(19) United States
(12) Patent Application Publication
(10) Pub. No.: US 2015/0095450 A1
(43) Pub. Date: Apr. 2, 2015

(54) UTILIZING MULTIPLE SWITCHABLE ADAPTATION SETS FOR STREAMING MEDIA DATA

(71) Applicant: QUALCOMM Incorporated, San Diego, CA (US)

(72) Inventors: Pavan Kumar VITTHALADEVUNI, San Diego, CA (US); Fatih ULUPINAR, San Diego, CA (US); Deviprasad PUTCHALA, San Diego, CA (US)

(73) Assignee: QUALCOMM Incorporated, San Diego, CA (US)

(21) Appl. No.: 14/041,588

(22) Filed: Sep. 30, 2013

(51) Int. Cl. H04L 12/825; H04L 29/06

(52) U.S. Cl. CPC H04L 47/25; H04L 65/602
USPC 709/217

(57) ABSTRACT

A device for retrieving media data includes one or more processors configured to determine an available amount of network bandwidth, select a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set, and retrieve data from the first representation and the second representation based on the selection.

### TECHNICAL FIELD

This disclosure relates to storage and transport of encoded video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for adapting streamed media data to changing available network bandwidth using two or more adaptation sets. That is, a client device may utilize multiple switchable adaptation sets for streaming media data. In general, these techniques include selecting representations from the multiple switchable adaptation sets such that the representations have similar normalized bitrates to each other. In this manner, as available network bandwidth fluctuates, the relative quality of the representations remains consistent with each other, which may provide an improved user experience.

In one example, a method of retrieving media data includes determining an available amount of network bandwidth, selecting a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set, and retrieving data from the first representation and the second representation based on the selection.

In another example, a device for retrieving media data includes one or more processors configured to determine an available amount of network bandwidth, select a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set, and retrieve data from the first representation and the second representation based on the selection.

In another example, a device for retrieving media data includes means for determining an available amount of network bandwidth, means for selecting a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set, and means for retrieving data from the first representation and the second representation based on the selection.

In another example, a computer-readable storage medium has stored thereon instructions that, when executed, cause a processor to determine an available amount of network bandwidth, select a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set, and retrieve data from the first representation and the second representation based on the selection.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a conceptual diagram illustrating a binning process consistent with the techniques of this disclosure.

FIG. 3 is a conceptual diagram illustrating selection of representations from two (or more) adaptation set in accordance with the techniques of this disclosure.

FIG. 4 is a conceptual diagram illustrating elements of example multimedia content.

FIG. 5 is a flowchart illustrating example techniques for retrieving media data in accordance with this disclosure.

FIG. 6 is a flowchart illustrating an example method for forming bins including representations selected from two different adaptation sets, in accordance with the techniques of this disclosure.

### DETAILED DESCRIPTION

In general, this disclosure describes techniques for using multiple switchable adaptation sets for media streaming, e.g., over a network. Streaming audio and video data over a computer-based network, such as the Internet, has become increasingly popular. The use of Dynamic Adaptive Streaming over HTTP (DASH) allows client devices to adapt to variations in available bandwidth that can occur along network paths between source devices and the client device. In particular, content producers often produce a set of representations, each having the same characteristics but coded at different bitrates. Such a set of representations is typically referred to as an “adaptation set.” A manifest file, such as a Media Presentation Description (MPD) of DASH, describes the characteristics of the representations of the adaptation sets, including bitrates for the representations, and also provides information for retrieving data of the representations, such as uniform resource locators (URLs) for segments (e.g., individual files) of the representations.

For example, for video data, each representation in an adaptation set may have the same number of views, be coded using the same video codec (e.g., ITU-T H.264/AVC or High Efficiency Video Coding (HEVC)), have the same spatial resolution, have the same frame rate, or the like. As another example, for audio data, each representation in an adaptation set may have the same number of channels (e.g., for surround sound), be coded using the same audio codec, or the like. In accordance with the techniques of this disclosure, a client device may implement bandwidth adaptation across multiple adaptation sets. For example, the client device may implement an algorithm that causes the client device to distribute available bandwidth between two or more adaptation sets, while avoiding any diminution in user experience. For instance, in a case where audio and video data are both available through respective adaptation sets with respective multiple representations, the client device performing the techniques of this disclosure may ensure that as the available bandwidth changes, the quality (measured in terms of bitrate) of both the audio and the video sets goes up or down together as much as possible.

A client device can select an adaptation set based on, e.g., decoding and/or rendering capabilities of the client device. For instance, a particular client device may be capable of displaying two images substantially simultaneously to produce a three-dimensional video effect, in which case the client device may select an adaptation set having two views (or one view plus depth information) for video data. As another example, a client device may have 5.1 surround sound, in which the client device may select an adaptation set having data for 5.1 channels, for audio data.

Providing an adaptation set including representations having different bitrates, but otherwise having the same characteristics, allows a client device to perform bandwidth adaptation among the representations of the adaptation set in response to variations in the available network bandwidth. For instance, if available network bandwidth increases, a client device may switch to a representation of the adaptation set having a relatively higher bitrate, to improve quality. As another example, if available network bandwidth decreases, the client device may switch to a representation of the adaptation set having a relatively lower bitrate, which, although may sacrifice some quality, allows the client device to avoid gaps in playout. In general, transitioning to a lower quality representation yields a better user experience than delaying playout to wait for additional data to arrive.

This disclosure describes various techniques for performing adaptation from among two or more adaptation sets. For example, a client device may select an adaptation set for video data and an adaptation set for audio data. The client device may then estimate available network bandwidth. This disclosure describes techniques for selecting representations from the video adaptation set and the audio adaptation set, based on bitrates of the representations of the adaptation sets and the available network bandwidth.

In general, this disclosure proposes selecting representations from the adaptation sets that have similar, relative bitrates among the available representations in the respective adaptation sets. In this manner, when available network bandwidth increases, quality of both audio and video data may be improved, whereas when available network bandwidth decreases, some amount of quality for both audio and video may be sacrificed to attempt to ensure continuous playout of the audio and video data. Moreover, the relative quality of the audio and video may be substantially similar when bandwidth adaptation is performed. These techniques can therefore avoid situations where the quality of the audio data is significantly higher than the quality of the video data, or vice versa, which may yield a less pleasant user experience.

In HTTP streaming, frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more periods. Periods may be defined by a Period element in the MPD. Each period may have an attribute start in the MPD. The MPD may include a start attribute and an availableStartTime attribute for each period. For live services, the sum of the start attribute of the period and the MPD attribute availableStartTime may specify the availability time of the period in UTC format, in particular the first Media Segment of each representation in the corresponding period. For on-demand services, the start attribute of the first period may be 0. For any other period, the start attribute may specify a time offset between the start time of the corresponding Period relative to the start time of the first Period. Each period may extend until the start of the next Period, or until the end of the media presentation in the case of the last period. Period start times may be precise. They may reflect the actual timing resulting from playing the media of all prior periods.

Each period may contain one or more representations for the same media content. A representation may be one of a number of alternative encoded versions of audio or video data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

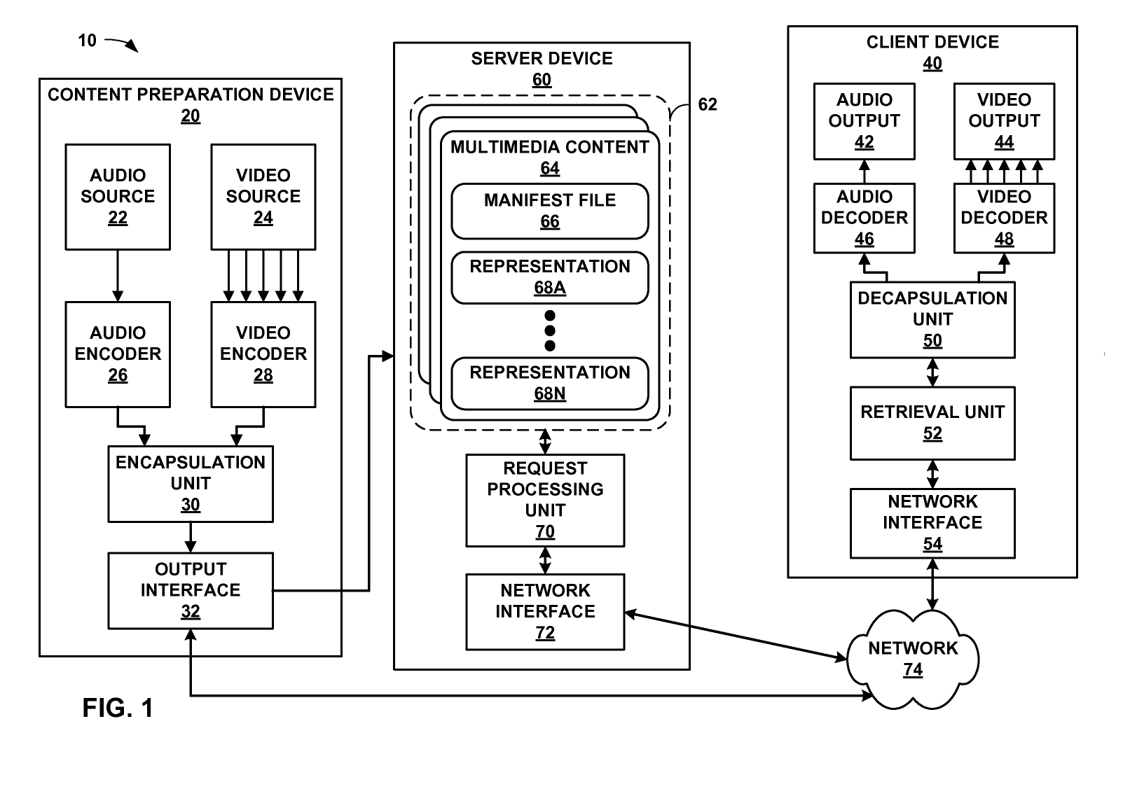

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the upcoming High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. In the example of H.264/AVC (Advanced Video Coding), coded video segments are organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture, hence coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SET messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol.

For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium 34, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

In accordance with the techniques of this disclosure, client device 40 (or, more specifically, retrieval unit 52) may be configured to bin rate representations of two or more adaptation sets. Retrieval unit 52 may prioritize the adaptation sets (for instance, video may be prioritized over audio). The binning process may follow reception of the MPD, or updating the MPD. Binning the rate representations may be performed as described below.

Assume, for purposes of explanation, that there are two adaptation sets, set 0 and set 1, and that set 0 has a higher priority than set 1. Assume further that set 0 includes NO representations, and set 1 has N1 representations. In this explanation, assume that representations are indexed using the format “R_{i,j},” where i represents the i^{th} adaptation set, and j represents the j^{th} representation in adaptation set i. Moreover, assume that the rate representations are sorted in decreasing order, that is, that within adaptation set “m,” representation R_{m,0} has the highest bitrate, and representation R_{m,N(m)} has the lowest bitrate. A combination of representations from set 0 and set 1 can be expressed as {R_{0,n}, R_{1,p}}, where nε{0, 1, . . . . N(0)} and pε{0, 1, . . . . N(1)}.

In general, higher bitrate representations from set 0 may be combined with higher bitrate representations from set 1, and likewise, lower bitrate representations from set 0 may be combined with lower bitrate representations from set 1. That is, retrieval unit 52 may determine a subset of possible combinations of representations from sets 0 and 1 such that the subset includes pairs of representations from sets 0 and 1 that have comparable relative bitrates. Retrieval unit 52 may form the subset of possible combinations of representations in accordance with the example binning process described below:
1. Within each adaptation set, calculate a normalized rate representation, R_{m,n}=R_{m,n}/R_{m,0}.
2. Calculate sum rate (S₀) for the first bin, which contains the highest rates of the 2 adaptation sets, namely (R_{0,0}, R_{1,0}), where S₀=R_{0,0}+R_{1,0}, and add S₀ to a sum-rate set.
3. If N₀>N₁: For each normalized rate representation, say “ro”, in {R_{0,n}} (n>1):
   a. Find a rate representation, say “r₁”, in {(R_{1,k}}, that is closest to “r₀”.
      i. Where possible, pick r₁ such that r₁<r₀.
   b. Add bin (R_{0,0}*r₀, R_{1,0}*r₁) to a composite rate representation set.
   c. Calculate the sum rate for this bin (Sᵢ), assuming the current bin is the i^{th} bin, as the sum of the elements, and add Sᵢ to the sum-rate set.
4. If N₀<N₁: For each normalized rate representation, say “r₁”, in {R_{1,n}} (n>1):
   a. Find a rate representation, say “r₁”, in {R_{1,k}}, that is closest to “r₁”.
      i. Where possible, pick r₀ such that r₁<r₀.
   b. Add bin (R_{0,0}*r₀, R_{1,0}*r₁) to a composite rate representation set.
   c. Calculate the sum rate for this bin (Sᵢ), assuming the current bin is the i^{th} bin, as the sum of the elements, and add Sᵢ to the sum-rate set.

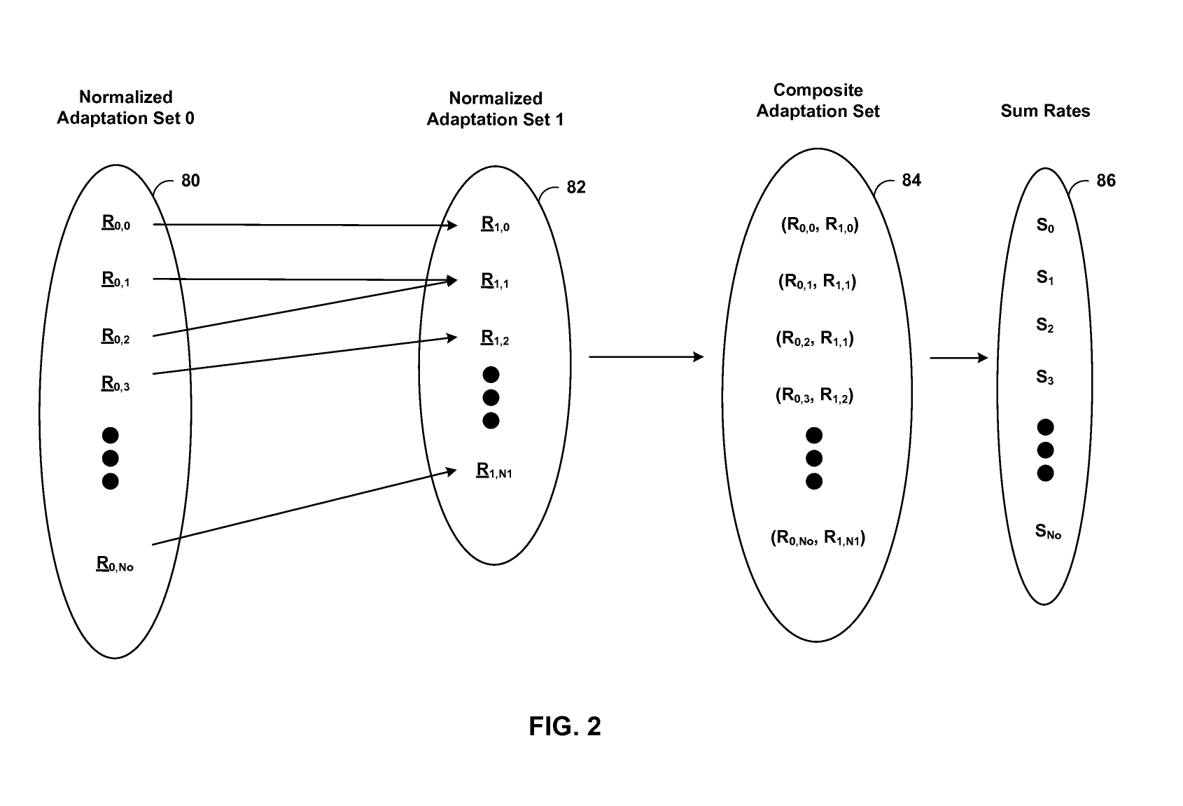

At the end of this procedure, there are “max (N₀, N₁)” number of bins, each with a possible combination of normalized rate representations of the two adaptation sets. This process is illustrated graphically in greater detail in FIG. 2.

FIG. 2 is a conceptual diagram illustrating an example binning process for combining representations from multiple adaptation sets. The example of FIG. 2 corresponds to the example adaptation set binning process described above with respect to FIG. 1. In particular, FIG. 2 illustrates adaptation set 0 as set 80 and adaptation set 1 as set 82. Arrows between representations of set 80 and set 82 represent pairs of representations between adaptation set 0 and adaptation set 1 resulting from either of steps 3a or 4a of the binning process described above. This binning process produces composite adaptation set 84.

In particular, in the example of FIG. 2, representations from adaptation set 0 and adaptation set 1 are paired as follows: R0,0 is paired with R1,0; R0,1 is paired with R1,1; R0,2 is paired with R1,1; and R0,N0 is paired with R1,N1. Thus, composite adaptation set 84 includes representation pairs {(R0,0, R1,0), (R0,1, R1,1), (R0,2, R1,1), (R0,3, R1,2), (R0,N0, R1,N1)}.

Furthermore, sum rates set 86 includes sum rates for respective representation pairs of composite adaptation set 84. In particular, S0 represents the combined rate of representations (R0,0, R1,0), S1 represents the combined rate of representations (R0,1, R1,1). S2 represents the combined rate of representations (R0,2, R1,1), S3 represents the combined rate of representations (R0,3, R1,2), and SN0 represents the combined rate of representations (R0,N0, R1,N1).

Table 1 below provides an example in which two adaptation sets include various representations. In particular, an adaptation set for video includes five representations, and an adaptation set for audio includes three representations. Table 1 further includes example normalized rates for each representation, as well as the composite adaptation set and sum rate set formed according to the example binning process described above.

It is assumed that the video adaptation set has a higher priority than the audio adaptation set in the example of Table 1. Because the video adaptation set includes five representations and the audio adaptation set includes three representations, the composite adaptation set includes five representations (the max of the audio and video adaptation sets, five in this case).

TABLE 1

| Video | | Audio | | | |
|---|---|---|---|---|---|
| | Normal- | | Normal- | | |
| Rate Rep | ized | Rate Rep | ized | Composite | Sum Rate |
| (kbps) | Rates | (kbps) | Rates | Adaptation Set | Rep (kbps) |
| 2048 | 1 | 256 | 1 | (1, 1) | 2304 |
| 1024 | 0.5 | 128 | 0.5 | (0.5, 0.5) | 1152 |
| 512 | 0.25 | 64 | 0.25 | (0.25, 0.25) | 576 |
| 256 | 0.125 | | | (0.125, 0.25) | 320 |
| 128 | 0.0625 | | | (0.0625, 0.25) | 192 |

Considering normalized rates, as shown in the example above, for binning can help club comparable quality audio with video, when there are multiple representations for both. That is, normalizing the rates allows retrieval unit 52 to pair a representation from the video adaptation set with a representation from the audio adaptation set such that the normalized bitrates for these representations are comparable. For instance, the bitrate for the video representation may have a position within the video adaptation set that is in a comparable position to the position for the bitrate of the audio representation within the audio adaptation set. In this manner, retrieval unit 52 may select a first representation from a first adaptation set and a second representation from a second adaptation set, such that the sum of a first bitrate for the first representation and a second bitrate for the second representation are less than or equal to the available amount of network bandwidth.

Distributing the available bandwidth between the two (or more) adaptation sets may further cause retrieval unit 52 to select representations from the adaptation sets in a manner that is different from conventional techniques, e.g., of M. Luby & L. Minder, “DASH Algorithms 2”, Proposal Version 20120206, Feb. 7, 2012. For instance, rather than using a currently selected rate representation as described in Luby & Minder, retrieval unit 52 may be configured to use a currently selected sum-rate representation. Similarly, the values of UP and DOWN described in Luby & Minder may be the highest sum-rate representations with rates of at most (x)*R and p(x)*R, respectively, where Rₑₛₜ is the Pker rate estimate. The value of NEXT may be chosen as described in Luby & Minder, but again, the rate may be the sum-rate representation for the two adaptation sets.

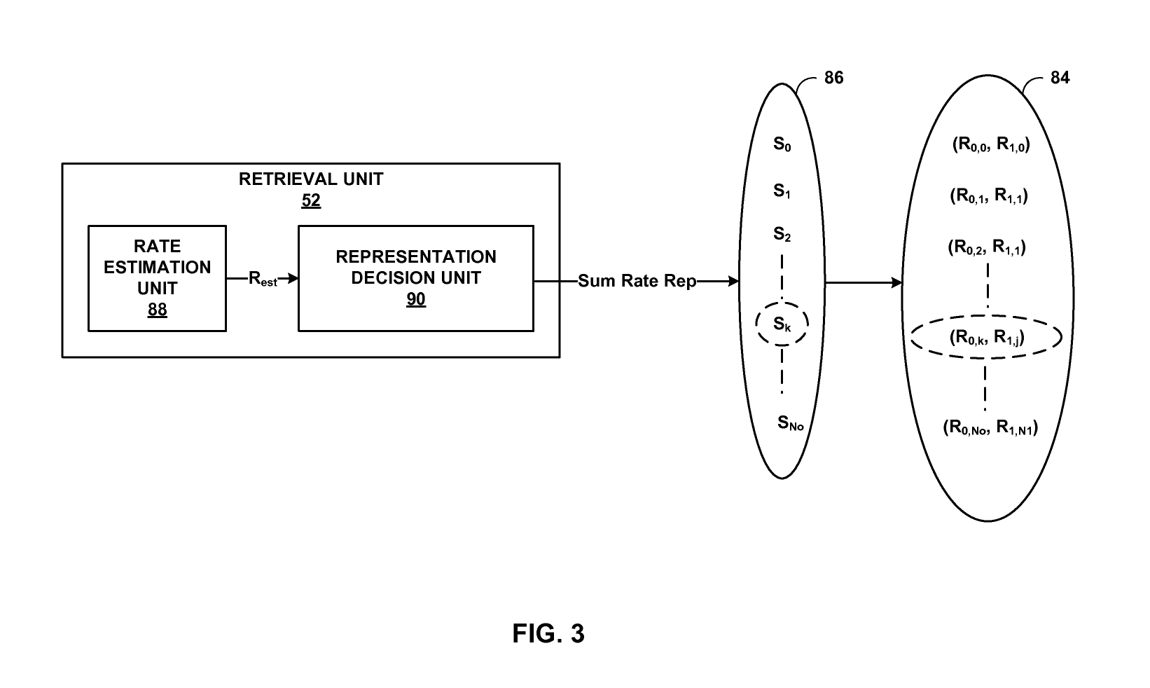

After determining the value of NEXT, retrieval unit 52 may map the sum value back to the individual rate representations through the process described in greater detail with respect to FIG. 3, below. This process is essentially the inverse of the process shown in FIG. 2, and this map-back may result in a unique solution to the rate representations, as this is a 1:1 mapping.

In other words, after forming the bins in this manner, retrieval unit 52 may perform bandwidth estimation and select representations based on the sum rates in the sum rate set (e.g., sum rates set 86). In particular, rather than adapting only one adaptation set to available bandwidth (e.g., only a video adaptation set), retrieval unit 52 may perform bandwidth adaptation among two or more adaptation sets, based on the available bandwidth and the rates of the sum rate set. In particular, retrieval unit 52 may select the pair of representations corresponding to the sum rate set that is highest, without exceeding the determined available amount of bandwidth.

In other words, client device 40 may be configured to select a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set.

As noted above, client device 40 may pair the representations from the adaptation sets such that the bitrates for the paired representations are comparable, e.g., such that the normalized bitrate for the representation from the first adaptation set in a bin is closest to the normalized bitrate for the representation from the second adaptation set in the bin. Then, client device 40 may select one of the bins, having a highest combined bitrate (the sum of the bitrate for the representation from the first adaptation set and the representation from the second adaptation set) without exceeding the available amount of network bandwidth. Client device 40 may then retrieve data from the first and second representations, e.g., by submitting respective HTTP GET or partial GET requests for segments of the first and second representations.

FIG. 3 is a conceptual diagram illustrating selection of representations from two (or more) adaptation set in accordance with the techniques of this disclosure. In this example, retrieval unit 52 (FIG. 1) includes rate estimation unit 88 and representation decision unit 90. Rate estimation unit 88 is generally configured to estimate a current amount of available network bandwidth, while representation decision unit 90 is configured to select representations of media content based on the estimated amount of available network bandwidth. In FIG. 3, rate estimation unit 88 passes the value “Rₑₛₜ” to representation decision unit 90. Rₑₛₜ, in this example, represents an example of data representative of the estimated amount of available network bandwidth (e.g., the available bitrate).

Representation decision unit 90 receives R, from rate estimation unit 88, in this example. Furthermore, representation decision unit 90 may receive a manifest file (e.g., manifest file 66), such as an MPD, for the media content. As explained above, the manifest file may include data defining one or more adaptation sets, as well as bitrates for representations of the adaptation sets. Representation decision unit 90 may construct sets 80, 82, 84, and 86 as discussed above with respect to FIG. 2. That is, assuming that there are two adaptation sets for the media data, representation decision unit 90 may construct two sets 80, 82 including bitrates for the representations of the two adaptation sets. Representation decision unit 90 may then construct composite adaptation set 84. e.g., in accordance with the algorithm explained with respect to FIG. 2. Representation decision unit 90 may further construct sum rates set 86, including summations of bitrates for respective pairs of representations of composite adaptation set 84.

After forming sum rates set 86 and composite adaptation set 84, representation decision unit 90 may receive R, from rate estimation unit 88. As discussed with respect to FIG. 2, sum rates set 86 may be sorted, e.g., such that lower combined (or “summed”) bitrates appear at the top, and higher combined bitrates appear at the bottom (or vice versa). Thus, representation decision unit 90 may determine which of the sum rates of sum rates set 86 is highest that does not exceed (but may equal) Rₑₛₜ. Assume, for purposes of discussion, that the highest sum rate that does not exceed Rₑₛₜ corresponds to sum rate Sₖ, where k is between 0 and N0, inclusive (assuming adaptation set 0 has more representations that adaptation set 1, per the example of FIG. 2). Sₖ, in the example of FIG. 3, is circled with a dashed outline, to represent that Sₖ is the combined bitrate that is highest without exceeding Rₑₛₜ.

Representation decision unit 90 may then determine the pair of representations of combined adaptation set 84 that corresponds to Sₖ, that is, the pair of representations including R_{0,k}. Of course, if adaptation set 1 (corresponding to set 82 in FIG. 2) had more representations that adaptation set 1 (corresponding to set 80 in FIG. 2), representation decision unit 90 may determine the pair of representations of the combined adaptation set that corresponds to Sₖ is the pair of representations including R_{1,k}. In any case, representation decision unit 90 may determine, in the example of FIG. 3, that retrieval unit 52 should retrieve data from representations R_{0,k} and R_{1,j}.

In this manner, retrieval unit 52 may be configured to selecting a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set. That is, the first representation may correspond to R_{0,k}, and the second representation may correspond to R_{1,j}, in this example.

Because construction of composite adaptation set 84 included grouping representations from adaptation sets 0 and 1 (sets 80 and 82, respectively) having similar normalized bitrates, representation R_{0,k} may be said to have a comparable position within adaptation set 0 to the position of representation R₁,j within adaptation set 1. Likewise, because representation decision unit 90 selects R_{0,k} and R_{1,j} such that their combined bitrates (Sₖ) does not exceed Rₑₛₜ, the sum of the bitrate for R_{0,k} and the bitrate for R_{1,j} is less than or equal to the available amount of network bandwidth, as selected by representation decision unit 90.

After representation decision unit 90 selects these two representations, retrieval unit 52 may retrieve data (e.g., segments or partial segments) from the selected representations. For instance, retrieval unit 52 may send HTTP GET or partial GET requests to, e.g., server device 60 to retrieve data of segments of the selected representations. In addition, if there are other representations that were selected independently (such as a timed text representation), retrieval unit 52 may also retrieve segments from those representations.

Rate estimation unit 88 and representation decision unit 90 may be functionally integrated into a single unit, e.g., retrieval unit 52 itself or into a single unit forming a portion of retrieval unit 52. Alternatively, functionality attributed to rate estimation unit 88 and/or representation decision unit 90 may be implemented in one or more discrete, separate units. Furthermore, the functionality attributed to rate estimation unit 88 and representation decision unit 90 may be implemented in hardware, software, or firmware, or any combination thereof. When implemented in software or firmware, it is presumed that requisite hardware is also provided (e.g., one or more processors or processing units, as well as computer-readable media to store instructions that can be executed by the one or more processors or processing units).

In this manner, client device 40 represents an example of a device for retrieving media data, the device including one or more processors configured to determine an available amount of network bandwidth, select a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set, and retrieve data from the first representation and the second representation based on the selection.

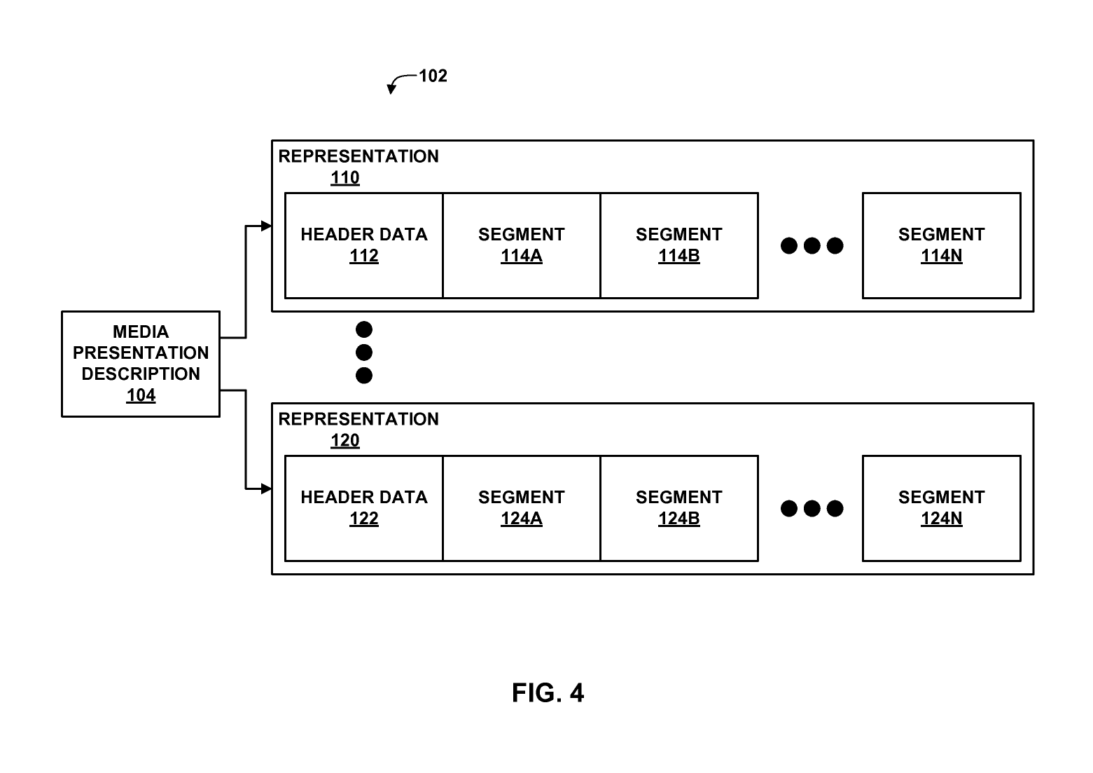

FIG. 4 is a conceptual diagram illustrating elements of example multimedia content 102. Multimedia content 102 may correspond to multimedia content 64 (FIG. 1), or another multimedia content stored in memory 62. In the example of FIG. 4, multimedia content 102 includes media presentation description (MPD) 104 and a plurality of representations 110-120. Representation 110 includes optional header data 112 and segments 114A-114N (segments 114), while representation 120 includes optional header data 122 and segments 124A-124N (segments 124). The letter N is used to designate the last movie fragment in each of representations 110, 120 as a matter of convenience. In some examples, there may be different numbers of movie fragments between representations 110, 120.

MPD 104 may comprise a data structure separate from representations 110-120. MPD 104 may correspond to manifest file 66 of FIG. I. Likewise, representations 110-120 may correspond to representations 68 of FIG. 1. In general, MPD 104 may include data that generally describes characteristics of representations 110-120, such as coding and rendering characteristics, adaptation sets, a profile to which MPD 104 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 112, when present, may describe characteristics of segments 114, e.g., temporal locations of random access points (RAPs, also referred to as stream access points (SAPs)), which of segments 114 includes random access points, byte offsets to random access points within segments 114, uniform resource locators (URLs) of segments 114, or other aspects of segments 114. Header data 122, when present, may describe similar characteristics for segments 124. Additionally or alternatively, such characteristics may be fully included within MPD 104.

Segments 114, 124 include one or more coded video samples, each of which may include frames or slices of video data. Each of the coded video samples of segments 114 may have similar characteristics. e.g., height, width, and bandwidth requirements. Such characteristics may be described by data of MPD 104, though such data is not illustrated in the example of FIG. 4. MPD 104 may include characteristics as described by the 3GPP Specification, with the addition of any or all of the signaled information described in this disclosure.

Each of segments 114, 124 may be associated with a unique uniform resource locator (URL). Thus, each of segments 114, 124 may be independently retrievable using a streaming network protocol, such as DASH. In this manner, a destination device, such as client device 40, may use an HTTP GET request to retrieve segments 114 or 124. In some examples, client device 40 may use HTTP partial GET requests to retrieve specific byte ranges of segments 114 or 124.

MPD 104 may include data defining adaptation sets that include respective groups of representations. For instance, representations 110 to 120 may form one adaptation set. Another adaptation set may include other representations not shown in FIG. 4. Alternatively, representation 110 may belong to one adaptation set and representation 120 may belong to another adaptation set. MPD 104 may additionally include data defining bitrates for representations within each adaptation set. Thus, a client device, such as client device 40, may use this data to determine pairs of representations from two adaptation sets (or additional groups of representations for larger numbers of adaptation sets) from which to retrieve media data. In the even that available bandwidth changes, client device 40 may adapt to the available bandwidth using each of the two (or more) adaptation sets, such that bitrates for representations selected from the adaptation sets are comparable (e.g., have similar normalized positions within the respective adaptation sets).

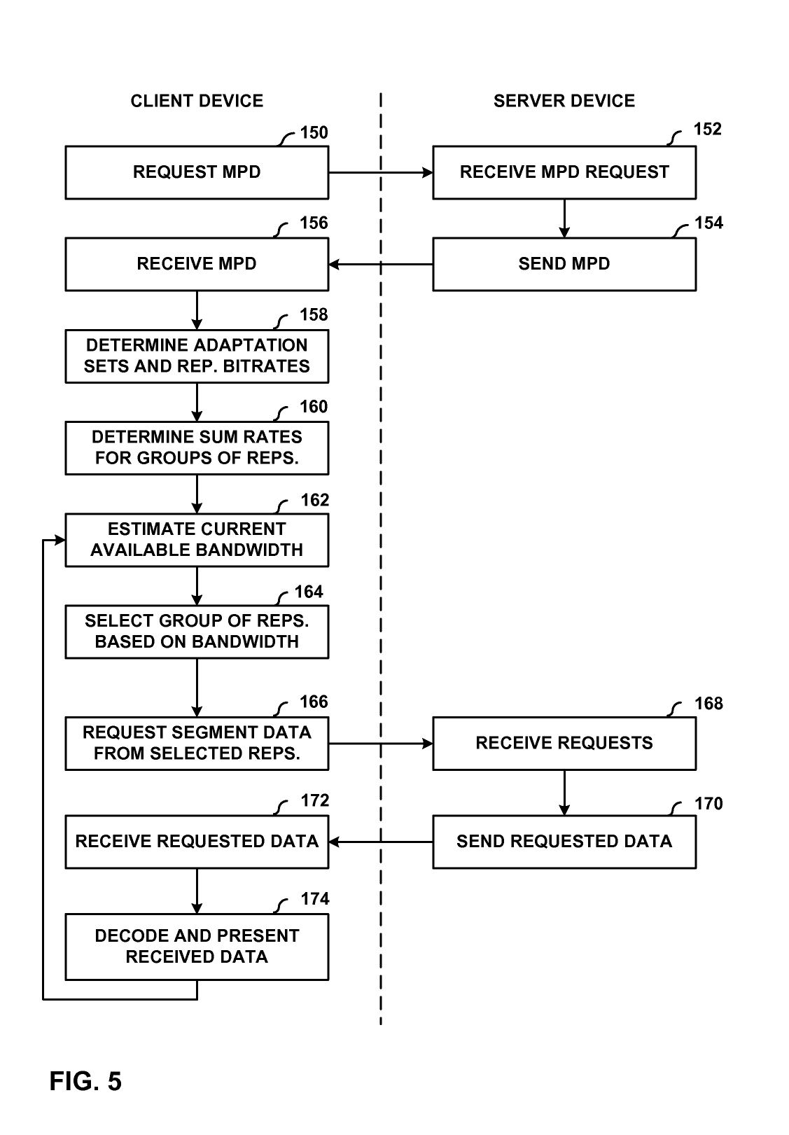

FIG. 5 is a flowchart illustrating example techniques for retrieving media data in accordance with this disclosure. The method of FIG. 5 is described primarily with respect to client device 40 and server device 60. However, it should be understood that other devices may be configured to perform this or a substantially similar method. For instance, content preparation device 20 may perform the functions attributed to the server device, in addition to or in the alternative to server device 60.

In the example of FIG. 5, client device 40 initially requests an MPD (150) from server device 60. The MPD may correspond to, for example, manifest file 66. After server device 60 receives the MPD request (152), server device 60 sends the MPD to client device 40 (154). Client device 40 thereafter receives the MPD from server device 60(156).

Client device 40 may then analyze the MPD to determine adaptation sets of the corresponding media content, as well as bitrates for representations of the adaptation sets (158). The media content may include a plurality of different adaptation sets with different types of media, e.g., video, audio, timed text, or other types of media. Client device 40 may then determine sum rates for groups of representations selected from the adaptation sets that are to be used for adapting to bandwidth variation (160). For instance, if the media content includes an adaptation set for audio data and an adaptation set for video data, client device 40 may determine bitrates for pairs of representations selected from the adaptation set for audio data and from the adaptation set for video data.

Client device 40 may then estimate the current available network bandwidth (162). This is shown with respect to the example of FIG. 3 as the value Rₑₛₜ. Client device 40 may then select a group (e.g., a pair or other tuple) of representations from the adaptation sets being used to adapt to the bandwidth based on the estimated amount of available bandwidth (164). In particular, client device 40 may select the group of representations such that the sum rate for the group is highest for the various determined groups, without exceeding the estimated bandwidth.

Client device 40 may then request segment data (e.g., all or portions of the segments) from the selected representations (166). For instance, if client device 40 selects an audio representation and a video representation, client device 40 may submit HTTP GET or partial GET requests for data of segments of the audio representation and the video representation. The segments of the representations may overlap temporally. That is, at least some of the data of the segment from one of the representations may overlap in terms of presentation time with data of the segment from the other of the representations.

In any case, server device 60 may then receive the requests for the segment data (168) and send the requested data to client device 40 (170). Client device 40, in turn, may receive the requested data (172) and may decode and present the received data (174). Assuming that playout has not yet finished, client device 40 may again estimate the current available bandwidth and again select a group of representations, assuming that the available bandwidth has changed.

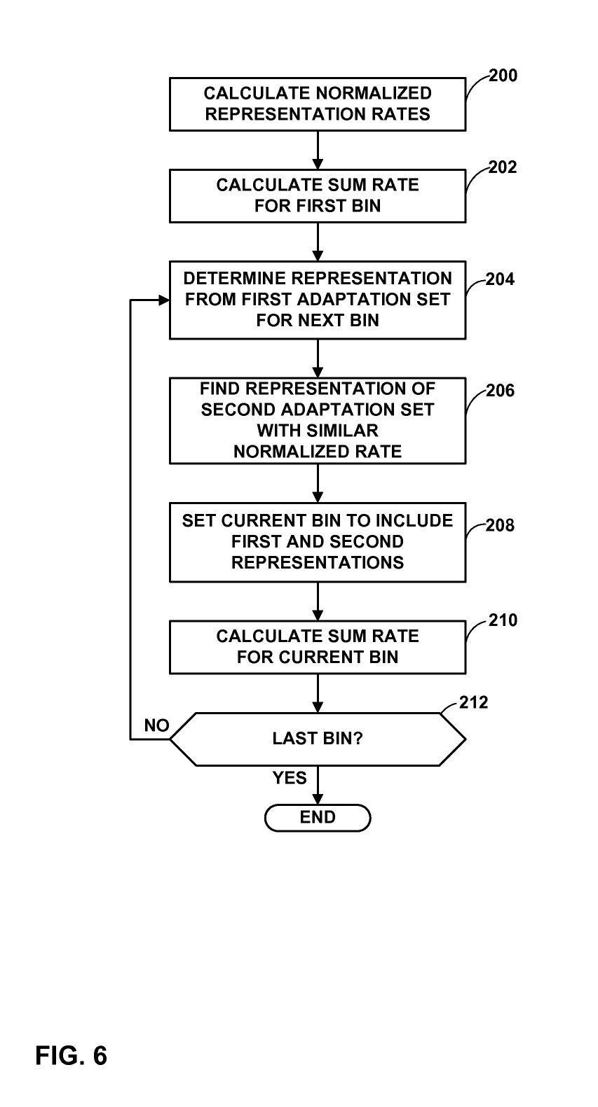

FIG. 6 is a flowchart illustrating an example method for forming bins including representations selected from two different adaptation sets, in accordance with the techniques of this disclosure. The method of FIG. 6 may generally correspond to step 160 of FIG. 5. Although described primarily with respect to client device 40, it should be understood that other devices may be configured to perform a substantially similar method.

Initially, client device 40 may calculate normalized representation rates (200) for representations of a set of adaptation sets. In the example of FIG. 6, it is assumed that there are two adaptation sets, but it should be understood that the number of adaptation sets may generally be N, where N is a positive integer value greater than 1. Client device 40 may calculate the normalized rates by iterating through each representation in a given adaptation set and dividing the bitrate for the current representation by the bitrate of the representation in the adaptation set having the highest bitrate.

Client device 40 may then calculate a sum rate for a first bin (202). As discussed above, this may include adding the bitrate of the representation of the first adaptation set having the lowest normalized bitrate to the bitrate of the representation of the second adaptation set having the lowest normalized bitrate. Assuming that the first adaptation set corresponds to the adaptation set having the most representations, client device 40 may next determine a representation from the first adaptation set for a next bin (204). Client device 40 may then find a representation of the second adaptation set having a normalized bitrate that is similar to the normalized bitrate of the determined representation from the first adaptation set (206).

Client device 40 may then set the current bin to include the first representation (determined at step 204) and the second representation (found at step 206). Client device 40 may further add the representations of the current bin to a composite adaptation set (e.g., composite adaptation set 84 of FIG. 3). Client device 40 may also calculate the sum rate for the current bin (210). That is, client device 40 may add the bitrates for the first and second representations together to form a sum rate for the current bin. Client device 40 may also add this sum rate to a sum rate set (e.g., set 86 of FIG. 2).

Next, client device 40 may determine whether the last bin has been formed (212). e.g., whether each representation in the first adaptation set has a pair in the composite adaptation set. If the last bin has not been formed (“NO” branch of 212), client device 40 may proceed to construct the next bin using steps 204-210. However, after forming the last bin, client device 40 may terminate this method, and proceed to use the bins to select representations based on estimated available network bandwidth.

In this manner, the methods of FIGS. 5 and 6 represent an example of a method including determining an available amount of network bandwidth, selecting a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set, and retrieving data from the first representation and the second representation based on the selection.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM. CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of retrieving media data, the method comprising:
determining an available amount of network bandwidth:
selecting a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set; and
retrieving data from the first representation and the second representation based on the selection.

2. The method of claim 1, wherein the first adaptation set includes representations of video content and wherein the second adaptation set includes representations of audio content.

3. The method of claim 1, wherein selecting comprises:
determining normalized bitrates for representations of the first adaptation set;
determining normalized bitrates for representations of the second adaptation set; and
selecting the first representation and the second representation such that the first representation has a normalized rate that is closest to a normalized rate for the second representation.

4. The method of claim 3, further comprising determining a first priority for the first adaptation set and a second priority for the second adaptation set, wherein selecting comprises:
when the first priority is higher than the second priority, selecting the second representation such that the normalized bitrate of the second representation is less than or equal to the normalized bitrate of the first representation; and
when the first priority is lower than the second priority, selecting the first representation such that the normalized bitrate of the first adaptation set is less than or equal to the normalized bitrate of the second representation.

5. The method of claim 1, wherein selecting comprises:
determining normalized bitrates for representations of the first adaptation set and for representations of the second adaptation set;
constructing a first bin including a highest bitrate representation of the first adaptation set and a highest bitrate representation of the second adaptation set;
when the number of representations in the first adaptation set is greater than the number of representations in the second adaptation set, constructing a bin for each representation in the first adaptation set, including a paired representation from the second adaptation set, such that the paired representation from the second adaptation set has a normalized bitrate that is closest to the normalized bitrate of the representation of the first adaptation set;
when the number of representations in the second adaptation set is greater than the number of representations in the first adaptation set, constructing a bin for each representation in the second adaptation set, including a paired representation from the first adaptation set, such that the paired representation from the first adaptation set has a normalized bitrate that is closest to the normalized bitrate of the representation of the second adaptation set; and
selecting one of the bins for which a combined bitrate for the representation from the first adaptation set and the second adaptation set is highest without exceeding the available amount of network bandwidth.

6. The method of claim 5,
wherein when the number of representations in the first adaptation set is greater than the number of representations in the second adaptation set, constructing at least one of the bins comprises constructing the at least one bin such that the paired representation from the second adaptation set has a normalized bitrate that is closest to and smaller than the normalized bitrate of the representation of the first adaptation set for the at least one bin, and
wherein when the number of representations in the second adaptation set is greater than the number of representations in the first adaptation set, constructing at least one of the bins comprises constructing the at least one bin such that the paired representation from the first adaptation set has a normalized bitrate that is closest to and greater than the normalized bitrate of the representation of the second adaptation set for the at least one bin.

7. The method of claim 1, further comprising:
selecting a third representation from a third adaptation set such that the sum of the first bitrate, the second bitrate, and a third bitrate for the third representation are less than or equal to the available amount of network bandwidth, and such that the third bitrate has a comparable position within the third adaptation set to the position of the first bitrate within the first adaptation set and to the second bitrate within the second adaptation set; and
retrieving data from the third representation based on the selection.

8. The method of claim 1, wherein retrieving the data from the first representation and the second representation comprises retrieving the data from the first representation substantially simultaneously with retrieving the data from the second representation.

9. The method of claim 1, wherein retrieving the data from the first representation and the second representation comprises retrieving at least a portion of a first segment from the first representation and retrieving at least a portion of a second segment from the second representation, wherein the first segment and the second segment have at least some playback time overlap.

10. The method of claim 1, further comprising determining a first priority for the first adaptation set and a second priority for the second adaptation set, wherein selecting comprises:
when the first priority is higher than the second priority, selecting the second representation such that the position of the second representation in the second adaptation set is less than or equal to the position of the first representation in the first adaptation set; and
when the first priority is lower than the second priority, selecting the first representation such that the position of the first representation in the first adaptation set is less than or equal to the position of the second representation in the second adaptation set.

11. A device for retrieving media data, the device comprising one or more processors configured to determine an available amount of network bandwidth, select a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set, and retrieve data from the first representation and the second representation based on the selection.

12. The device of claim 11, wherein the first adaptation set includes representations of video content and wherein the second adaptation set includes representations of audio content.

13. The device of claim 11, wherein to select the first representation and the second representation, the one or more processors are configured to determine normalized bitrates for representations of the first adaptation set, determine normalized bitrates for representations of the second adaptation set, and select the first representation and the second representation such that the first representation has a normalized rate that is closest to a normalized rate for the second representation.

14. The device of claim 13, wherein the one or more processors are configured to determine a first priority for the first adaptation set and a second priority for the second adaptation set, and wherein to select the first representation and the second representation, the one or more processors are configured to, when the first priority is higher than the second priority, select the second representation such that the normalized bitrate of the second representation is less than or equal to the normalized bitrate of the first representation, and when the first priority is lower than the second priority, select the first representation such that the normalized bitrate of the first representation is less than or equal to the normalized bitrate of the second representation.

15. The device of claim 11, wherein to select the first representation and the second representation, the one or more processors are configured to determine normalized bitrates for representations of the first adaptation set and for representations of the second adaptation set, construct a first bin including a highest bitrate representation of the first adaptation set and a highest bitrate representation of the second adaptation set, when the number of representations in the first adaptation set is greater than the number of representations in the second adaptation set, construct a bin for each representation in the first adaptation set, including a paired representation from the second adaptation set, such that the paired representation from the second adaptation set has a normalized bitrate that is closest to the normalized bitrate of the representation of the first adaptation set, when the number of representations in the second adaptation set is greater than the number of representations in the first adaptation set, construct a bin for each representation in the second adaptation set, including a paired representation from the first adaptation set, such that the paired representation from the first adaptation set has a normalized bitrate that is closest to the normalized bitrate of the representation of the second adaptation set, and select one of the bins for which a combined bitrate for the representation from the first adaptation set and the second adaptation set is highest without exceeding the available amount of network bandwidth.

16. The device of claim 15, wherein when the number of representations in the first adaptation set is greater than the number of representations in the second adaptation set, the one or more processors are configured to construct at least one of the bins such that the paired representation from the second adaptation set has a normalized bitrate that is closest to and smaller than the normalized bitrate of the representation of the first adaptation set for the at least one bin, and wherein when the number of representations in the second adaptation set is greater than the number of representations in the first adaptation set, the one or more processors are configured to construct at least one of the bins such that the paired representation from the first adaptation set has a normalized bitrate that is closest to and greater than the normalized bitrate of the representation of the second adaptation set for the at least one bin.

17. The device of claim 11, wherein the one or more processors are configured to select a third representation from a third adaptation set such that the sum of the first bitrate, the second bitrate, and a third bitrate for the third representation are less than or equal to the available amount of network bandwidth, and such that the third bitrate has a comparable position within the third adaptation set to the position of the first bitrate within the first adaptation set and to the second bitrate within the second adaptation set, and retrieve data from the third representation based on the selection.

18. The device of claim 11, wherein the one or more processors are configured to retrieve the data from the first representation substantially simultaneously with retrieving the data from the second representation.

19. The device of claim 11, wherein the one or more processors are configured to retrieve at least a portion of a first segment from the first representation and retrieve at least a portion of a second segment from the second representation, wherein the first segment and the second segment have at least some playback time overlap.

20. The device of claim 11, wherein the one or more processors are configured to determine a first priority for the first adaptation set and a second priority for the second adaptation set, and wherein to select the first representation and the second representation, the one or more processors are configured to, when the first priority is higher than the second priority, select the second representation such that the position of the second representation in the second adaptation set is less than or equal to the position of the first representation in the first adaptation set, and when the first priority is lower than the second priority, select the first representation such that the position of the first representation in the first adaptation set is less than or equal to the position of the second representation in the second adaptation set.

21. A device for retrieving media data, the device comprising:
means for determining an available amount of network bandwidth;
means for selecting a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set; and
means for retrieving data from the first representation and the second representation based on the selection.

22. The device of claim 21, wherein the first adaptation set includes representations of video content and wherein the second adaptation set includes representations of audio content.

23. The device of claim 21, wherein the means for selecting comprises:
means for determining normalized bitrates for representations of the first adaptation set;
means for determining normalized bitrates for representations of the second adaptation set; and
means for selecting the first representation and the second representation such that the first representation has a normalized rate that is closest to a normalized rate for the second representation.

24. The device of claim 23, further comprising means for determining a first priority for the first adaptation set and a second priority for the second adaptation set, wherein the means for selecting comprises:
means for selecting, when the first priority is higher than the second priority, the second representation such that the normalized bitrate of the second representation is less than or equal to the normalized bitrate of the first representation; and
means for selecting, when the first priority is lower than the second priority, the first representation such that the normalized bitrate of the first adaptation set is less than or equal to the normalized bitrate of the second representation.

25. The device of claim 21, wherein the means for selecting comprises:
means for determining normalized bitrates for representations of the first adaptation set and for representations of the second adaptation set;
means for constructing a first bin including a highest bitrate representation of the first adaptation set and a highest bitrate representation of the second adaptation set;
means for constructing, when the number of representations in the first adaptation set is greater than the number of representations in the second adaptation set, a bin for each representation in the first adaptation set, including a paired representation from the second adaptation set, such that the paired representation from the second adaptation set has a normalized bitrate that is closest to the normalized bitrate of the representation of the first adaptation set;
means for constructing, when the number of representations in the second adaptation set is greater than the number of representations in the first adaptation set, a bin for each representation in the second adaptation set, including a paired representation from the first adaptation set, such that the paired representation from the first adaptation set has a normalized bitrate that is closest to the normalized bitrate of the representation of the second adaptation set; and
means for selecting one of the bins for which a combined bitrate for the representation from the first adaptation set and the second adaptation set is highest without exceeding the available amount of network bandwidth.

26. The device of claim 25,
wherein the means for constructing, when the number of representations in the first adaptation set is greater than the number of representations in the second adaptation set, comprises means for constructing at least one of the bins such that the paired representation from the second adaptation set has a normalized bitrate that is closest to and smaller than the normalized bitrate of the representation of the first adaptation set for the at least one bin, and
wherein the means for constructing, when the number of representations in the second adaptation set is greater than the number of representations in the first adaptation set, comprises means for constructing at least one bin such that the paired representation from the first adaptation set has a normalized bitrate that is closest to and greater than the normalized bitrate of the representation of the second adaptation set for the at least one bin.

27. The device of claim 21, further comprising:
means for selecting a third representation from a third adaptation set such that the sum of the first bitrate, the second bitrate, and a third bitrate for the third representation are less than or equal to the available amount of network bandwidth, and such that the third bitrate has a comparable position within the third adaptation set to the position of the first bitrate within the first adaptation set and to the second bitrate within the second adaptation set; and
means for retrieving data from the third representation based on the selection.

28. The device of claim 21, wherein the means for retrieving the data from the first representation and the second representation comprises means for retrieving the data from the first representation substantially simultaneously with retrieving the data from the second representation.

29. The device of claim 21, wherein the means for retrieving the data from the first representation and the second representation comprises means for retrieving at least a portion of a first segment from the first representation and means for retrieving at least a portion of a second segment from the second representation, wherein the first segment and the second segment have at least some playback time overlap.

30. The device of claim 21, further comprising means for determining a first priority for the first adaptation set and a second priority for the second adaptation set, wherein the means for selecting comprises:
means for selecting, when the first priority is higher than the second priority, the second representation such that the position of the second representation in the second adaptation set is less than or equal to the position of the first representation in the first adaptation set; and
means for selecting, when the first priority is lower than the second priority, selecting the first representation such that the position of the first representation in the first adaptation set is less than or equal to the position of the second representation in the second adaptation set.

31. A computer-readable storage medium having stored thereon instructions that, when executed, cause a processor to:
determine an available amount of network bandwidth;
select a first representation from a first adaptation set and a second representation from a second adaptation set, such that the sum of a first bitrate for the first representation and a second bitrate for the second representation are less than or equal to the available amount of network bandwidth, and such that the first bitrate has a comparable position within the first adaptation set to a position of the second bitrate within the second adaptation set; and
retrieve data from the first representation and the second representation based on the selection.

32. The computer-readable storage medium of claim 31, wherein the first adaptation set includes representations of video content and wherein the second adaptation set includes representations of audio content.

33. The computer-readable storage medium of claim 31, wherein the instructions that cause the processor to select comprise instructions that cause the processor to:
determine normalized bitrates for representations of the first adaptation set;
determine normalized bitrates for representations of the second adaptation set; and
select the first representation and the second representation such that the first representation has a normalized rate that is closest to a normalized rate for the second representation.

34. The computer-readable storage medium of claim 33, further comprising instructions that cause the processor to determine a first priority for the first adaptation set and a second priority for the second adaptation set, wherein the instructions that cause the processor to select comprise instructions that cause the processor to:
when the first priority is higher than the second priority, select the second representation such that the normalized bitrate of the second representation is less than or equal to the normalized bitrate of the first representation; and
when the first priority is lower than the second priority, select the first representation such that the normalized bitrate of the first adaptation set is less than or equal to the normalized bitrate of the second representation.

35. The computer-readable storage medium of claim 31, wherein the instructions that cause the processor to select comprise instructions that cause the processor to:
determine normalized bitrates for representations of the first adaptation set and for representations of the second adaptation set;
construct a first bin including a highest bitrate representation of the first adaptation set and a highest bitrate representation of the second adaptation set;
when the number of representations in the first adaptation set is greater than the number of representations in the second adaptation set, construct a bin for each representation in the first adaptation set, including a paired representation from the second adaptation set, such that the paired representation from the second adaptation set has a normalized bitrate that is closest to the normalized bitrate of the representation of the first adaptation set;
when the number of representations in the second adaptation set is greater than the number of representations in the first adaptation set, construct a bin for each representation in the second adaptation set, including a paired representation from the first adaptation set, such that the paired representation from the first adaptation set has a normalized bitrate that is closest to the normalized bitrate of the representation of the second adaptation set; and
select one of the bins for which a combined bitrate for the representation from the first adaptation set and the second adaptation set is highest without exceeding the available amount of network bandwidth.

36. The computer-readable storage medium of claim 35,
wherein when the number of representations in the first adaptation set is greater than the number of representations in the second adaptation set, the instructions that cause the processor to construct at least one of the bins comprise instructions that cause the processor to construct the at least one bin such that the paired representation from the second adaptation set has a normalized bitrate that is closest to and smaller than the normalized bitrate of the representation of the first adaptation set for the at least one bin, and
wherein when the number of representations in the second adaptation set is greater than the number of representations in the first adaptation set, the instructions that cause the processor to construct at least one of the bins comprise instructions that cause the processor to construct the at least one bin such that the paired representation from the first adaptation set has a normalized bitrate that is closest to and greater than the normalized bitrate of the representation of the second adaptation set for the at least one bin.

37. The computer-readable storage medium of claim 31, further comprising instructions that cause the processor to:
select a third representation from a third adaptation set such that the sum of the first bitrate, the second bitrate, and a third bitrate for the third representation are less than or equal to the available amount of network bandwidth, and such that the third bitrate has a comparable position within the third adaptation set to the position of the first bitrate within the first adaptation set and to the second bitrate within the second adaptation set; and
retrieve data from the third representation based on the selection.

38. The computer-readable storage medium of claim 31, wherein the instructions that cause the processor to retrieve the data from the first representation and the second representation comprise instructions that cause the processor to retrieve the data from the first representation substantially simultaneously with retrieving the data from the second representation.

39. The computer-readable storage medium of claim 31, wherein the instructions that cause the processor to retrieve the data from the first representation and the second representation comprise instructions that cause the processor to retrieve at least a portion of a first segment from the first representation and retrieving at least a portion of a second segment from the second representation, wherein the first segment and the second segment have at least some playback time overlap.

40. The computer-readable storage medium of claim 31, further comprising instructions that cause the processor to determine a first priority for the first adaptation set and a second priority for the second adaptation set, wherein the instructions that cause the processor to select comprise instructions that cause the processor to:
when the first priority is higher than the second priority, select the second representation such that the position of the second representation in the second adaptation set is less than or equal to the position of the first representation in the first adaptation set; and
when the first priority is lower than the second priority, select the first representation such that the position of the first representation in the first adaptation set is less than or equal to the position of the second representation in the second adaptation set.
